(19) United States
(12) Patent Application Publication
(10) Pub. No.: US 2026/0135781 A1
(43) Pub. Date: May 14, 2026

(54) MAPPING FOR SEAMLESS SERVICE QUALITY IN MIXED NETWORK ENVIRONMENTS

(71) Applicant: Cisco Technology, Inc., San Jose, CA (US)

(72) Inventors: Peiman Amini, Fremont, CA (US); Jerome Henry, Pittsboro, NC (US); Ardalan Alizadeh, Milpitas, CA (US); Matthew Aaron Silverman, Shaker Heights, OH (US)

(73) Assignee: Cisco Technology, Inc., San Jose, CA (US)

(21) Appl. No.: 19/253,360

(22) Filed: Jun. 27, 2025

Related U.S. Application Data
(60) Provisional application No. 63/718,812, filed on Nov. 11, 2024.

(51) Int. Cl. H04L 41/50

(52) U.S. Cl. CPC H04L 41/50

(57) ABSTRACT

Mapping for seamless service quality in mixed network environments may be provided. Network conditions and network traffic types may be determined on a network. Next, a mapping may be created from first parameters to second parameters based on the network conditions and the network traffic types. Then service may be provided on the network based on the mapping.

### RELATED APPLICATION

Under provisions of 35 U.S.C. § 119(e), Applicant claims the benefit of U.S. Provisional Application No. 63/718,812 filed Nov. 11, 2024, which is incorporated herein by reference.

### TECHNICAL FIELD

The present disclosure relates generally to providing mapping for seamless service quality in mixed network environments.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing mapping for seamless service quality in mixed network environments;

FIG. 2 is a flow chart of a method for providing mapping for seamless service quality in mixed network environments; and

FIG. 3 is a block diagram of a computing device.

### DETAILED DESCRIPTION

### Overview

Mapping for seamless service quality in mixed network environments may be provided. Network conditions and network traffic types may be determined on a network. Next, a mapping may be created from first parameters to second parameters based on the network conditions and the network traffic types. Then service may be provided on the network based on the mapping.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In wireless access network environments, the transition between the Institute of Electrical and Electronics Engineers (IEEE) 802.11e wireless standards and wired IP-based networks, while maintaining a consistent Quality of Service (QoS) for all devices, may present a challenge. This may be complex in scenarios where new devices equipped with Low Latency, Low Loss, Scalable Throughput (L4S) capabilities are introduced alongside legacy devices that do not support these advancements. The addition of L4S-capable devices may threaten to overshadow the QoS needs of these legacy devices, particularly in applications sensitive to latency such as Voice over Internet Protocol (VoIP), gaming, and video conferencing for example.

The discrepancy between how QoS is managed in wireless versus wired segments may worsen these challenges, leading to potential service quality degradations for legacy devices. This inconsistency may come from a lack of a standardized process to seamlessly translate the wireless network's User Priorities (UP) and Access Categories (AC) into the wired domain's Differentiated Services Code Point (DSCP) values. Specifically, there may be no system in place to ensure that the introduction of L4S traffic does not compromise the latency requirements of legacy devices, making effective end-to-end QoS management and optimization across mixed-device networks difficult.

To confront this issue, embodiments of the disclosure may provide a unified QoS mapping mechanism within a wireless Local Area Network (LAN) controller. Embodiments of the disclosure may ensure consistent QoS across diverse network environments, balancing the advanced capabilities of L4S-supporting devices with the fundamental QoS requirements of legacy systems, thereby preventing a compromise in service quality for legacy users.

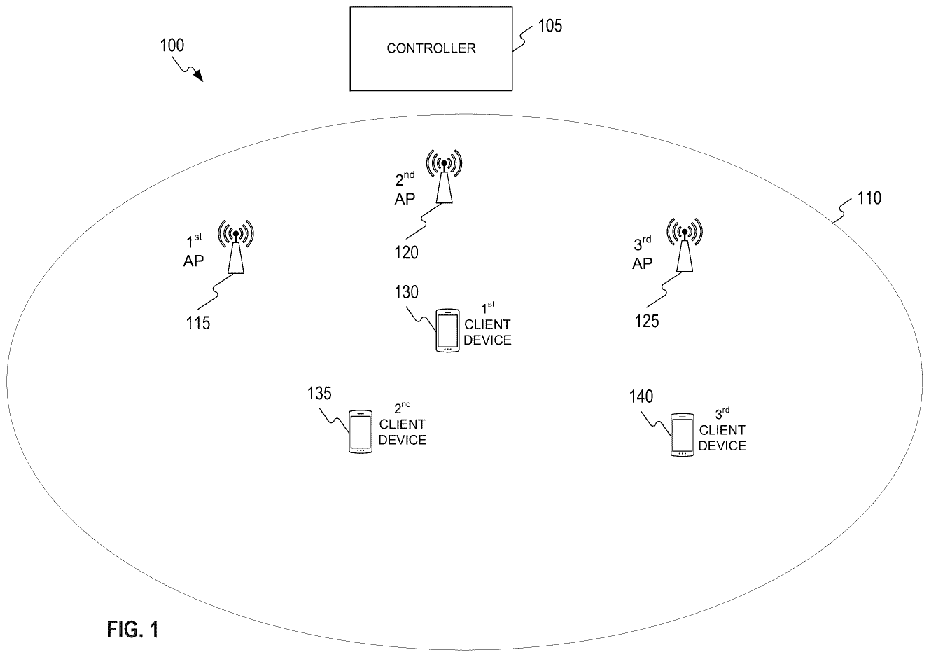

FIG. 1 shows an operating environment 100 for providing mapping for seamless service quality in mixed network environments. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example. Furthermore, ones of the plurality of client devices may have L4S capabilities and other ones of the plurality of client devices may be legacy devices that may not support L4S capabilities.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and the plurality of client devices may also have an Ultra-Wide Band (UWB) radio that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide mapping for seamless service quality in mixed network environments.

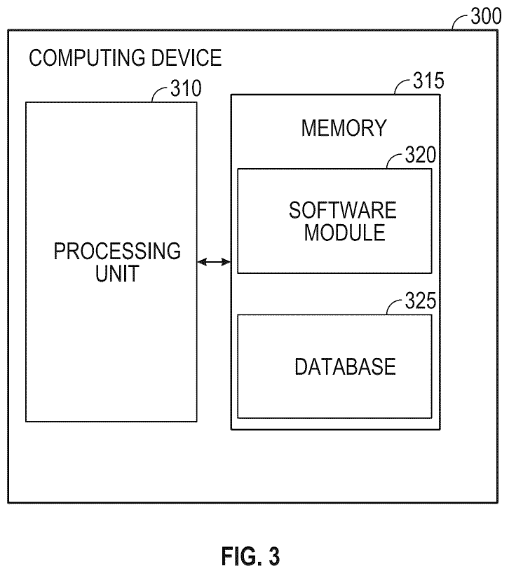

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

As wireless network environments become increasingly diverse, the integration of devices supporting L4S alongside legacy devices may present a challenge. Particularly in scenarios where some legacy devices are sensitive to delays, ensuring a consistent QoS without adversely impacting these devices may be crucial. Embodiments of the disclosure may address this challenge by introducing a unified QoS mapping process. This process may bridges the gap between the dynamic QoS needs of L4S applications and the static capabilities of conventional legacy systems. By dynamically translating User Priorities (UP) and Access Categories (AC) into Differentiated Services Code Point (DSCP) across both IEEE 802.11 wireless and IP-based wired network domains, embodiments of the disclosure may not only preserve low latency for advanced applications, but may also ensures that legacy devices may not experience deteriorated service quality.

### Unified QoS Mapping Mechanism

Embodiments of the disclosure may bridge the gap in QoS consistency between IEEE 802.11 wireless domains and Internet Protocol (IP)-based wired networks. This may be accomplished by dynamically translating UP and AC into DSCP settings for L4S applications, in accordance with the principles outlined in IEEE 802.11e and the Differentiated Services (DiffServ) architecture.

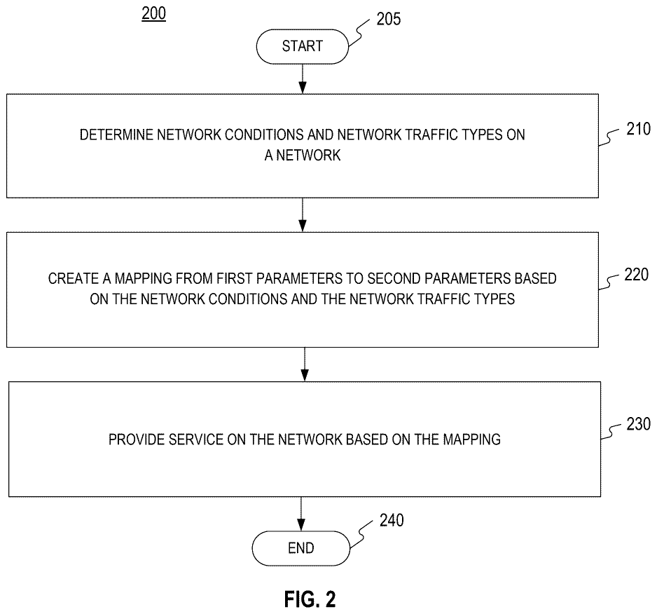

FIG. 2 is a flow chart setting forth the general stages involved in a method 200 consistent with embodiments of the disclosure for providing mapping for seamless service quality in mixed network environments. Method 200 may be implemented using a computing device 300 as described in more detail below with respect to FIG. 3. Computing device 300 may be embodied by controller 105 for example. Ways to implement the stages of method 200 will be described in greater detail below.

Method 200 may begin at starting block 205 and proceed to stage 210 where computing device 300 may determine network conditions and network traffic types on a network. For example, IEEE 802.11e metrics may be leveraged for data collection. By collecting real-time traffic metrics such as Medium Time (MT), Physical Rate (PR), and Queue Size (QS) from wireless segments for example, embodiments of the disclosure may effectively classify and prioritize traffic. Advanced packet inspection and flow analysis techniques may be used focusing on Access Category specifications, which may be used for managing traffic according to its priority and nature.

From stage 210, where computing device 300 determines the network conditions and the network traffic types on a network, method 200 may advance to stage 220 where computing device 300 may create a mapping from first parameters to second parameters based on the network conditions and the network traffic types. For example, a rule-based decision engine may be adapted to align with DiffServ architectures. Embodiments of the disclosure may use a rule-set that may be harmoniously aligned with the DiffServ model. This may include the integration of Behavioral Aggregate (BA) classifiers, mapping UP/AC to DSCP based on network conditions and traffic types. Consistent with embodiments of the disclosure, the first parameters may comprise at least one of User Priorities (UP) and Access Categories (AC). The second parameters may comprise Differentiated Services Code Point (DSCP) values for example.

Moreover, condition-based triggers may be activated by DiffServ markers such as Excess Traffic Marking (ETM) and Dynamic Flow Provisioning (DFP), allowing for responsive adjustments to network load and latency requirements. For example, for an online gaming platform, the decision engine may map the UP for gaming traffic (e.g., UP 4) to a DSCP value of 34 (e.g., assigned for video), now specifically optimized for L4S to reduce latency and ensure a smooth gaming experience.

Furthermore, dynamic QoS mapping based on real-time conditions may be implemented. By employing a dynamic mapping table that cross-references current network performance metrics with predefined QoS policies, adjustments to DSCP markings may be made in accordance with IEEE P802.1p/Q tagging standards. This may involve on-the-fly packet marking and traffic shaping at the network edge, ensuring that packets entering the wired segment adhere to established L4S criteria. For example, during a major corporate webinar or event, embodiments of the disclosure may detect increased packet traffic from web conferencing tools and may dynamically adjust DSCP values to prioritize this traffic. This may insure it is treated as L4S with low latency and minimal loss.

Embodiments of the disclosure may also enforce policies using IEEE network control protocols. Utilizing network control protocols such as IEEE 802.1Q-2014 for Virtual Local Area Network (VLAN) tagging and priority handling, embodiments of the disclosure may include incorporating a real-time protocol for QoS adjustment. This may allow for immediate application of policy changes based on continuous traffic evaluation, similar to the capabilities provided by IEEE 802.1Qbv for Enhanced Transmission Selection. For example, when a video streaming service experiences high traffic during peak hours, the network may automatically implement high-priority DSCP settings for this service, using IEEE 802.1Q VLAN tagging to maintain seamless streaming quality, crucial for L4S compliance.

In addition, a feedback and optimization loop may enhance system responsiveness. Integrating a feedback system with existing network management tools to provide real-time alerts and performance analytics may be proved by embodiments of the disclosure. Regular updates to the rule-based engine with data derived from performance feedback may fine-tune QoS mappings, optimizing the network's performance and ensuring high-quality service delivery.

In another embodiment, comprehensive administrative controls and compliance logging may be provided. A network management interface compliant with IEEE standards may be provided for manual overrides and configurations. This interface may support logging and reporting features that track changes in QoS settings, offering an audit trail for compliance with both internal policies and industry standards for example.

Once computing device 300 creates the mapping from the first parameters to the second parameters based on the network conditions and the network traffic types in stage 220, method 200 may continue to stage 230 where computing device 300 may provide service on the network based on the mapping. For example, by dynamically translating UPs and ACs into DSCP across both wireless and IP-based wired network domains, embodiments of the disclosure may not only preserves low latency for advanced applications but may also ensure that legacy devices do not experience deteriorated service quality. Once computing device 300 provides service on the network based on the mapping in stage 230, method 200 may then end at stage 240.

### Contextual QoS Calibration

Embodiments of the disclosure may leverage Network-Based Application Recognition (NBAR) integrated within WLCs to interpret and dynamically translate User Priorities (UP) and Access Categories (AC) into Differentiated Services Code Point (DSCP) values specifically configured for L4S traffic. This may allow for adaptive QoS handling as traffic moves between different network domains (wireless to wired), enhancing the end-to-end service quality. The overall stages for such process may be described below.

An initial traffic classification may be performed at APs. For example, embodiments may use APs to perform initial traffic classification based on IEEE 802.11e standards, where packets may be promptly identified by their UP. For instance, VoIP packets may be classified as UP 5, which may be reserved for voice communications. This classification may be enhanced through Deep Packet Inspection (DPI) to verify that the traffic aligns with its designated priority, ensuring it is correctly identified as real-time audio data.

Next, enhanced traffic analysis with NBAR may be performed. Upon receipt of traffic data, embodiments may consider the deployment of NBAR within WLCs to conduct a more granular analysis. NBAR may identify packets from recognized applications, such as telecommunications applications for VoIP calls, by analyzing packet payloads for application-specific signatures. This detailed recognition process may enable the system to understand both the nature of the traffic and its associated network requirements.

Based on the comprehensive traffic analysis provided by NBAR and aligned with predefined QoS policies, embodiments may dynamically assign appropriate DSCP values tailored for L4S traffic. For example, for voice communications like VoIP, DSCP 46 (EF—Expedited Forwarding) may be selected to prioritize these packets, reducing latency and enhancing reliability during transmission.

Once the DSCP marking is set, embodiments may ensure that the prioritized packets maintain their high-priority status as they transition from wireless to wired domains. Network devices across the board may be configured to recognize and act on DSCP values, thus fast-tracking packets marked with DSCP 46. This unified approach across devices may ensure minimal queuing delays and optimized throughput, preserving the integrity and quality of the VoIP communication.

Embodiments of the disclosure may provide continuous monitoring of network conditions and VoIP traffic performance by the WLC. Should there be any indication of performance degradation or significant changes in traffic patterns, the system may re-evaluate and potentially adjust DSCP mappings. This adaptive strategy may allow for ongoing refinement of QoS policies and mappings, ensuring that the network may remain flexible and responsive to varying traffic demands.

### Adaptive Policy Adjustment for Dynamic QoS Optimization in WLC

Embodiments of the disclosure may provide an adaptive policy adjustment feature within the WLC that may allow for real-time modifications to the UP/AC to DSCP mappings. This aspect may respond to the current network conditions, application demands, and prevailing traffic patterns, thereby optimizing QoS delivery for latency-sensitive applications such as video conferencing and VoIP.

The system may continuously monitor the network, identifying conditions such as increased congestion or elevated levels of specific types of traffic, particularly during peak usage hours. By assessing these conditions in real-time, the WLC may gain a comprehensive understanding of the network's performance and the specific QoS needs at any given moment.

In response to detected congestion and a surge in video conferencing traffic, embodiments may implement a process that temporarily adjusts the UP/AC to DSCP mappings to more aggressively prioritize video and voice traffic. This dynamic response may be crucial for maintaining the clarity and reliability of real-time communication, ensuring that these applications perform optimally even under strained network conditions.

As network traffic stabilizes and returns to normal conditions, the system may automatically revert the mappings to their standard configurations. This reversion may be seamlessly executed, maintaining a balance between exceptional performance during peak times and efficient resource utilization during normal or low-traffic periods.

The adaptive policy feature may also play a role in establishing a protocol that may ensure interoperability and compatibility across various network environments and devices, including legacy systems. By adhering to standardized L4S principles, this protocol may not only enhance the reach, but may also amplify the effectiveness of the unified QoS strategy across diverse network infrastructures.

The integration of new devices equipped with L4S capabilities alongside legacy devices without such support presents a significant challenge in maintaining consistent QoS, especially for latency-sensitive applications. This discrepancy between device capabilities may lead to degraded service for legacy devices within mixed-device network environments. Embodiments of the disclosure may provide a unified QoS mapping process that may ensure seamless QoS consistency by dynamically translating wireless UP and AC into wired network's DSCP values, effectively balancing the needs of both L4S-capable and legacy devices.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing mapping for seamless service quality in mixed network environments as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining network conditions and network traffic types on a network;
creating a mapping from first parameters to second parameters based on the network conditions and the network traffic types; and
providing service on the network based on the mapping.

2. The method of claim 1, wherein determining the network conditions and the network traffic types comprises collecting at least one real-time traffic metric comprising: Medium Time (MT), Physical Rate (PR), and Queue Size (QS).

3. The method of claim 1, wherein creating the mapping comprises using a rule-based decision engine.

4. The method of claim 1, wherein creating the mapping comprises creating the mapping dynamically based on real-time conditions.

5. The method of claim 1, wherein creating the mapping comprises creating the mapping based on application layer characteristics.

6. The method of claim 1, wherein the first parameters comprise at least one of User Priorities (UP) and Access Categories (AC).

7. The method of claim 1, wherein the second parameters comprise Differentiated Services Code Point (DSCP) values.

8. A system comprising:
a memory storage; and
a processing unit coupled to the memory storage, wherein the processing unit is operative to:
determine network conditions and network traffic types on a network;
create a mapping from first parameters to second parameters based on the network conditions and the network traffic types; and
provide service on the network based on the mapping.

9. The system of claim 8, wherein the processing unit being operative to determine the network conditions and the network traffic types comprises the processing unit being operative to collect at least one real-time traffic metric comprising:
Medium Time (MT), Physical Rate (PR), and Queue Size (QS).

10. The system of claim 8, wherein the processing unit being operative to create the mapping comprises the processing unit being operative to use a rule-based decision engine.

11. The system of claim 8, wherein the processing unit being operative to create the mapping comprises the processing unit being operative to create the mapping dynamically based on real-time conditions.

12. The system of claim 8, wherein the processing unit being operative to create the mapping comprises the processing unit being operative to create the mapping based on application layer characteristics.

13. The system of claim 8, wherein the first parameters comprise at least one of User Priorities (UP) and Access Categories (AC) and wherein the second parameters comprise Differentiated Services Code Point (DSCP) values.

14. A non-transitory computer-readable medium that stores a set of instructions which when executed perform a method executed by the set of instructions comprising:
determining network conditions and network traffic types on a network;
creating a mapping from first parameters to second parameters based on the network conditions and the network traffic types; and
providing service on the network based on the mapping.

15. The non-transitory computer-readable medium of claim 14, wherein determining the network conditions and the network traffic types comprises collecting at least one real-time traffic metric comprising: Medium Time (MT), Physical Rate (PR), and Queue Size (QS).

16. The non-transitory computer-readable medium of claim 14, wherein creating the mapping comprises using a rule-based decision engine.

17. The non-transitory computer-readable medium of claim 14, wherein creating the mapping comprises creating the mapping dynamically based on real-time conditions.

18. The non-transitory computer-readable medium of claim 14, wherein creating the mapping comprises creating the mapping based on application layer characteristics.

19. The non-transitory computer-readable medium of claim 14, wherein the first parameters comprise at least one of User Priorities (UP) and Access Categories (AC).

20. The non-transitory computer-readable medium of claim 14, wherein the second parameters comprise Differentiated Services Code Point (DSCP) values.
